(19) United States
(12) Patent Application Publication
(10) Pub. No.: US 2007/0022116 A1
(43) Pub. Date: Jan. 25, 2007

(54) System and method for handling files incoming to a computer

(75) Inventor: Douglas C. Smith, Los Gatos, CA (US)

Correspondence Address: DALLAS OFFICE OF FULBRIGHT & JAWORSKI L.L.P., 2200 ROSS AVENUE, SUITE 2800, DALLAS, TX, 75201-2784, US

(73) Assignee: Specialty Patent Group, Inc., Dallas, TX (US)

(21) Appl. No.: 11/271,371

(22) Filed: Nov. 10, 2005

Related U.S. Application Data
(60) Provisional application No. 60/702,310, filed on Jul. 25, 2005.

(51) Int. Cl. G06F 7/00

(52) U.S. Cl. 707/7

(57) ABSTRACT

Advantage is taken in the fact that the files that operate beyond a single application, for example, (executable files) are files having extensions which are already known to the system and which extensions must be appended to a file name in the last position of the file name. In one embodiment, when a file is incoming to a computer system the executable nature of the file is temporarily inhibited by modifying the last extension. This modification can be by appending a new “safe” extension to the end of the file name, which appended extension must be removed before the file will execute. The safe extension could, if desired, convey information to the user about the nature of the file. In one embodiment, files containing potentially troubling data are identified to the user. In another embodiment, the user must acknowledge his/her desire to open an executable file.

This application claims priority benefit of U.S. Provisional Patent Application No. 60/702,310 entitled “SYSTEM AND METHOD FOR HANDLING FILES INCOMING TO A COMPUTER,” filed Jul. 25, 2005, the disclosure of which is hereby incorporated herein by reference.

### FIELD OF THE INVENTION

This invention relates to processing of files incoming to a computer system and more particularly to systems and methods for reducing the risk of contamination of the system from files containing damaging data.

### BACKGROUND OF THE INVENTION

Certain computer operating systems, such as, for example, the well-know Windows) operating system from Microsoft, allow a user to simply “click” on a filename to open or execute the file. In the Windows system, as in other systems, each file has a name identifying the file. Following the name proper (usually separated by a period “.”) there are “extensions” that denote, both to the user and to the system certain attributes of the file. One such attribute is the application that created the file (such as a particular word processing application or a particular spreadsheet) another such attribute is the file type (such as compression). One such extension of several possible extensions is the EXE extension which marks the file as an executable file to a Windows operating system. This means that the file contains data designed in a manner to provide instructions to the operating system that the operating system uses to effect changes to system operation, as opposed to merely running within a single defined pre-established application. Such a file is a computer program as opposed to a data file such as a word processing document. Other file extensions that operate beyond a specific application include .pif, .scr, .com.

If the user clicks on an executable file, the file will open and run the instructions contained therein. Thus, if an executable file contains malicious material, such as a virus, it is possible to “infect” the entire computer system in ways detrimental not only to the computer system on which the virus resides, but to other computer systems networked thereto or in communication therewith. Thus, preventing a computer system from becoming infected with a virus, or other malicious data, is economically desirable.

Compounding the problem is the fact that in many situations the default display mode of the computer system is to remove the last file extension in a filename from view. Thus, if a filename is displayed as “letter to mom” its full filename could be “letter to mom.doc”. The “.doc” would be suppressed. Accordingly, a file named, “happy time” could, in reality, actually be named “happy time.exe”. If that file contained malicious code and an unsuspecting user opened the file thinking it was, for example, a note from a trusted friend, the user could be in for a nasty surprise. Since the nature of malicious code is to be subversive, often the user does not even know until a file is opened that his/her computer system has become infected. At that point, it is too late to prevent damage.

In some instances, the full filename of the file “happy time” could have been “happy time.doc.exe”. In such a situation, the “.exe” would have been removed from view, (hidden) and the filename would appear to the user as “happy time.doc” thereby encouraging even a savvy user (i.e., a user who recognizes that a “.exe” extension is potentially a problem) to open it.

There are many methods for files to enter a computer system. One such method is via email which arrives at a computer system carrying with it an “attachment” in the form of one or more files having names as discussed above. Another such method is the arrival at a computer system (via email, disk, etc.) of a compressed set of files (zip, gzip, etc.) which, when uncompressed, contain files having malicious data within them. To the unwary, and often even to those who are trained, such files are a source of trouble when opened. To further compound the problem, some files are designed to be self-opening when placed on a system. Thus, when a file is “unzipped” it can be infected and if it has a certain filename extension could be opened to the detriment of the user's system. It is possible for some file types that normally run within a single defined pre-established application, such as .doc files, to harbor macro viruses that can damage the computer system in much the same way as do programs.

### BRIEF SUMMARY OF THE INVENTION

Advantage is taken in the fact that the files that operate beyond a single application, for example, (executable files) are files having extensions which are already known to the system and which extensions must be appended to a filename in the last position of the filename. In one embodiment, when a file is incoming to a computer system the executable nature of the file is temporarily inhibited by modifying the last extension. This modification can be by appending a new “safe” extension to the end of the filename, which appended extension must be removed before the file will execute. The safe extension could, if desired, convey information to the user about the nature of the file.

In one embodiment, files containing potentially troubling data are identified to the user. In another embodiment, the user must acknowledge his/her desire to open an executable file.

### BRIEF DESCRIPTION OF THE DRAWINGS

For a more complete understanding of the present invention, reference is now made to the following descriptions taken in conjunction with the accompanying drawings, in which:

FIG. 1 shows one embodiment of a flow chart for processing files incoming to a computer;

FIG. 2 shows one embodiment of a flow chart for processing the opening of files on a computer system;

FIG. 3 shows one embodiment of a computer system upon which the processes of FIGS. 1 and 2 can be run; and

FIGS. 4A and 4B show embodiments of displays for alerting a user to executable files.

### DETAILED DESCRIPTION OF THE INVENTION

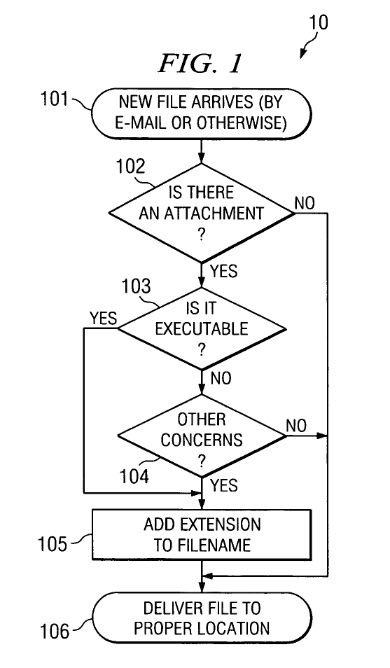

FIG. 1 shows one embodiment 10 of a flow chart for processing files incoming to a computer. In process 101 a new file arrives at the computer system either as an email attachment, a zip file or in a program or other application. In process 101 a determination is made as to whether this is an email. If it is, then process 102 determines if there is an attachment to the email, if not then the email is delivered to the proper location for use by the user of the system. If process 101 on the other hand determines that there was no email or if process 102 determines that there is an attachment, then the file or email is looked at or unzipped if necessary and process 103 determines by an extension of the filename whether it is an executable file. If it is, then the extension is modified by process 105. This modification can be by adding a new extension, such as .saf at the end of the file extension, by removing the .exe, or by adding the original extension(s) to the filename and adding a new extension, or by moving the executable (or all) extensions to a non-executable location within said filename, or a combination thereof. Also, note that different types of files can have different modifications so that the user could observe the modification and know something about the file or something about what caused the file to be marked in the manner that it was. The modification (new file extensions) could be an indication of risk level of the file. For example, a file named mypictjpg.exe could become mypictjpg.exe.saf, or could become mypictexejpg (where the executable extension “exe” is moved within the filename proper) or could become mypictjpg.saf. This last possibility, however removes the user's ability to properly run the file (program).

Process 103 determines that a file does not appear to be executable because of its extension name then process 104 looks for other concerns, for example, microviruses in MS WORD documents or JPEG picture files containing programs. If, for example, a JPEG picture file or a sound file contains a program hidden within the file then process 105 modifies the extension as discussed above. If process 104, on the other hand, determines that there are no concerns with respect to the nomenclature of the file name then the file is available to be delivered or stored at the proper location within the system.

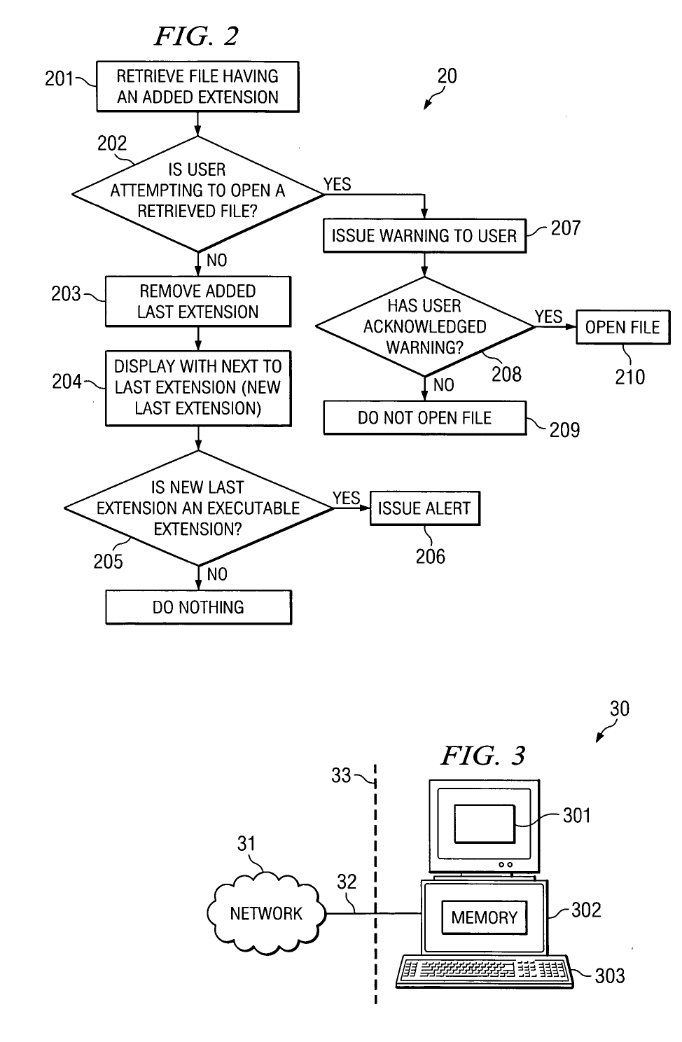

FIG. 2 shows one embodiment 20 of a flow chart for processing the opening of files on a computer system. As shown in FIG. 2 process 201 retrieves the file having an added extension. Process 202 determines if the user is attempting to open a retrieved file, if not then the system removes from view the added last extension via process 203 and process 204 system displays the file with the next to the last extension which becomes the new last extension. Process 205 determines if the new last extension is an executable extension. If it is, then process 206 issues an alert. This alert can be a sound alert or a visual alert such as, for example, changing the color of the file name on the screen to red to signify caution in opening the file. If the user is attempting to open the retrieved file, then process 207 issues a warning to the user which could be an audio gong or a message or the color alert. If process 208 makes a determination as to whether the user has acknowledged the warning and if so opens the file via process 210 and if not does not allow the file to open process 209 until the user has acknowledged that there is a potential danger in the file since it is an executable file. Note that optionally at process 208, in addition to issuing a warning to the user, the system could have sent the file for a virus scan via process 209 and similarly with respect to process 206 in addition to issuing an alert the system could send the file to a virus scan via process 207. 1

FIG. 3 shows one embodiment 30 of a computer system upon which the process of FIGS. 1 and 2 can be run. As shown in FIG. 3, PC 33 consists of processor 302, screen 301, keyboard 303 and memory 304. PC 33 is connected to the outside world via network 31 and connection 32. Connection 32, of course, can be wireless or wireline and is available as is well known to receive information such as, for example, email with attachments. Also, files zipped or otherwise can be downloaded via communication path 32 to PC 33 as is well known.

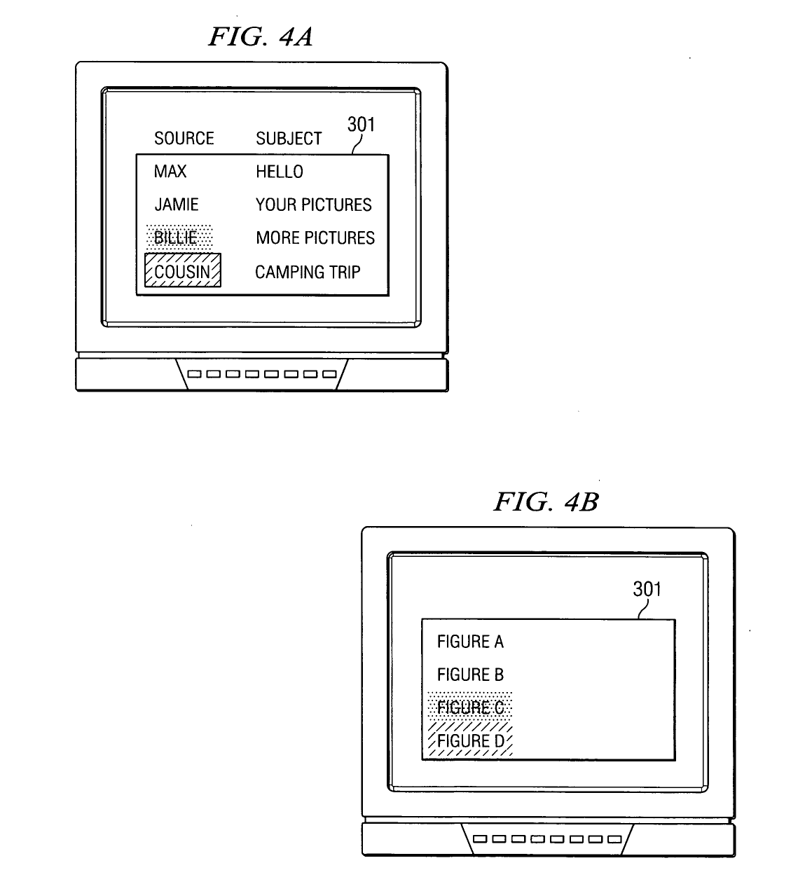

FIG. 4A shows screen 301 displaying an email screen with the source of the email message in the subject. Note that the email from Billie is highlighted in a color, such as blue, indicating that there could be a program masquerading as a different type of a file which has been detected because of the file name extension or because it was detected via process 104 (FIG. 1). Also note the cousin in FIG. 4A is shown in a different color, such as red, to indicate that the file attachment called “camping trip” might very well be an executable file and in many cases a file which has had its extension modified for protection purposes as discussed above.

FIG. 4B shows display 301 where file C is highlighted, such as red, to show that file C, perhaps coming from a zip drive or from an email attachment has been found to have an executable extension in its file name. Note that as discussed above, different colors can be used or different extension names can be used to indicate to the user the nature of the potential problem. Color, font style, font size, position on the screen, audible warning when the file is being opened, blinking text, a box around the text (perhaps with colored borders, are examples of attributes that can be used to identify potentially troublesome files. Note that the added extension and/or an attribute displayed to a user, can demote the severity of the potential trouble. For example, saf and .sal could be shown as low risk while .smh could be a high risk file.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.
What is claimed is:

1. A method for processing files incoming to a computer, said method comprising:
detecting an incoming file having an executable extension as part of the filename of said incoming file; and
modifying any said filename detected to have an executable extension to prevent execution of said file, said modifying being such as to allow the original filename to be recovered.

2. The method of claim 1 wherein said modifying comprises:
appending at least one extension onto said executable extension, said appended extension being positioned to be at the end of the file name extension.

3. The method of claim 2 further comprising:
using said appended extension indicates the possible risk inherent in the file having a detected executable extension.

4. The method of claim 2 wherein said modifying comprises:
moving said detected executable extension to a position within the filename proper.

5. The method of claim 1 wherein said incoming file is selected from the list of e-mail, zip, gzip, tar.

6. The method of claim 1 further comprising:
detecting an incoming file that does not have an executable extension appended to the name of said incoming file, but that does have a specific extension; and
modifying any said detected specific extension, by adding an extension to the filename.

7. The method of claim 6 wherein said specific extension is a family of extensions.

8. The method of claim 7 wherein the specific extensions within said family are changed from time to time.

9. The method of claim 1 further comprising:
displaying said file having an executable extension in a manner calculated to alert a user that said file appears to be an executable file.

10. The method of claim 9 wherein said display provides a risk level associated with said file.

11. The method of claim 1 fuirther comprising:
providing an alert when said user attempts to open a file having a modified extension.

12. The method of claim 2 further comprising:
providing an alert when said user attempts to open a file having an executable extension.

13. The method of handling files in a computer operating system, said method comprising:
giving each file a name identifying said file, said filename having appended thereto at least one extension, said extension identifying said file's characteristics to said operating system; and
when a particular file extension is identified as being of a certain type, appending a marker to said filename so as to prevent said extension from interacting with said computer system while still preserving its ability to so interact under user control.

14. The method of claim 13 further comprising:
when a user attempts to run a file having an extension of said certain type, requiring said user to move said particular file extension to a position within said filename to allow said operating system to run said certain type file.

15. The method of claim 13 further comprising:
when a user attempts to run a file of said certain type, issuing an alert to said user that said file has a potential of being a file having certain characteristics.

16. The method of claim 13 further comprising:
masking said marker extension when displaying said file name so as to expose to view said certain type extension.

17. The method of claim 16 wherein said certain type file extension is the .exe extension.

18. The method of claim 13 wherein said marker extension identifies said certain type extension to which said marker extension is appended.

19. The method of claim 13 further comprising:
displaying files to a user such that said characteristics are made known to said user by attributes of said display.

20. The method of claim 19 wherein said attributes are selected from the list comprising:
color, font style, font size, position on the screen, audible warning when file is selected, blinking text, enclosure in a box, colored borders around text, severity of a possible problem.

21. A web browser comprising:
means for receiving file attachments to messages destined for delivery to a computer system; and
means for appending a safe file extension to the filename extension of each received file attachment prior to delivery of said file attachment to said computer system, said safe file extension preventing unwanted execution of said file.

22. The web browser of claim 21 wherein said appending means comprises:
means for appending said safe file extensions only to files that by their filename extension appear to be executable.

23. The web browser of claim 21 wherein said safe file extension is appended to the file name as the last extension of said file name.

24. The web browser of claim 23 further comprising:
means for moving other file extensions to a non-executable position within said filename.

25. The web browser of claim 21 further comprising:
means for alerting a user that a received file appears to be executable.

26. The web browser of claim 21 further comprising:
means for virus checking any file that appears to be executable.

27. The web browser of claim 22 wherein said appended file extension denotes the severity of a possible problem with a file to which said appended file extension is attached.

28. The web browser of claim 21 further comprising:
means for using said appended file extension to indicate to a user the nature of a file to which said appended file extension is attached.

29. A computer system comprising:
means for receiving file attachments to messages destined for delivery to a computer system; and
means for moving at least one original filename extension to a position within a name of said file attachment so as to prevent execution of said file.

30. The computer system of claim 29 wherein said safe file extension conveys to a computer system user information about the file, said information obtained from the last file extension prior to said appending of said safe file extension.

31. The computer system of claim 29 wherein said moving comprises the addition of an extension as a last extension to a file name.

32. A software computer product having a computer-readable media for controlling files incoming to a computer, said software computer product comprising:
code for modifying the file name of any file incoming to said computer, said modifying making said file non-executable by rearranging the filename of said while preserving all portions of said incoming filename.

33. The software computer product of claim 32 fuirther comprising:
determining when a file extension of a filename is executable; and
inhibiting said modifying for non-executable filenames.

34. The software computer product of claim 32 further comprising:
code for alerting a user that a file is executable prior to said file being opened.
